(19) United States
(12) Patent Application Publication
(10) Pub. No.: US 2017/0039425 A1
(43) Pub. Date: Feb. 9, 2017

(54) SYSTEM AND METHOD FOR OPTIMIZING CHEMIGATION OF CROPS

(71) Applicant: Prospera Technologies, Ltd., Tel-Aviv (IL)

(72) Inventors: Raviv ITZHAKY, Maale Adumim (IL); Daniel KOPPEL, Raanana (IL); Simeon SHPIZ, Bat Yam (IL)

(73) Assignee: Prospera Technologies, Ltd., Tel-Aviv (IL)

(21) Appl. No.: 15/066,814

(22) Filed: Mar. 10, 2016

Related U.S. Application Data
(60) Provisional application No. 62/202,790, filed on Aug. 8, 2015.

(51) Int. Cl. G06K 9/00; C05B 1/02; A01N 53/00; A01N 59/20; A01N 59/00

(52) U.S. Cl. CPC G06K 9/00657; A01N 59/20; A01N 59/00; A01N 53/00; C05B 1/02

(57) ABSTRACT

A system and method for optimizing chemigation of a crop. The method includes: identifying at least one image of at least one portion of the crop; analyzing, via machine imaging, the at least one image to identify at least one reference image respective of the crop; determining, based on the at least one reference image, at least one abnormality respective of the crop; and generating a chemical composition for treating the at least one abnormality.

### CROSS-REFERENCE TO RELATED APPLICATIONS

This application claims the benefit of U.S. Provisional Application No. 62/202,790 filed on Aug. 8, 2015, the contents of which are hereby incorporated by reference.

### TECHNICAL FIELD

The present disclosure relates generally to chemigation, and more specifically to optimizing chemigation injections in crops.

### BACKGROUND

Despite the rapid growth of the use of technology in many industries, agriculture continues to utilize manual labor to perform the tedious and often costly processes for growing vegetables, fruits, and other crops. One primary driver of the continued use of manual labor in agriculture is the need for guidance and consultation by experienced agronomists with respect to developing plants. In particular, such guidance and consultation is crucial to the success of larger farms.

Agronomy is the science of producing and using plants for food, fuel, fiber, and land reclamation. Agronomy involves use of principles from a variety of arts including, for example, biology, chemistry, economics, ecology, earth science, and genetics. Modern agronomists are involved in issues such as improving quantity and quality of food production, managing the environmental impacts of agriculture, extracting energy from plants, and so on. Agronomists often specialize in areas such as crop rotation, irrigation and drainage, plant breeding, plant physiology, soil classification, soil fertility, weed control, and insect and pest control.

The plethora of duties assumed by agronomists require critical thinking to solve problems. For example, when planning to improve crop yields, an agronomist must study a farm's crop production in order to discern the best ways to plant, harvest, and cultivate the plants, regardless of climate. Additionally, agronomists must develop methods for controlling weeds and pests to keep crops disease free. To these ends, the agronomist must continually monitor progress to ensure optimal results.

Pursuant to the need to monitor progress, agronomists frequently visit the fields in which crops are grown to assess the plant production and to identify and solve any problems encountered. Solving the crop problems may include, for example, updating the instructions for chemicals and/or fertilizers used on the crops, altering a watering schedule, removing harmful wildlife from the fields, and so on.

Agronomists often use mathematical and analytical skills in conducting their work and experimentation. Complex data resulting from such use must be converted into a format that is ready for public consumption. As a result, agronomists communicate their findings via a wide range of media, including written documents, presentations, speeches, and so on. Such communication must further take diplomacy into consideration, particularly when the communication involves sensitive matters.

Reliance on manual observation of plants to identify and address problems is time-consuming, expensive, and subject to human error. Additionally, even when agronomists frequently observe the plants, problems may not be identified immediately. Such stalled identification leads to slower response times. As a result, the yield of such plants may be sub-optimal, thereby resulting in lost profits.

One particular problem agronomists commonly address is the need to add chemicals, nutrients, fertilizers, and other substances to plants to promote growth. Such substances may include, for example, pesticides, herbicides, fungicides, fertilizers, soil conditioners, and so on. Existing solutions for providing plants with substances include depositing the substances onto plants via, for example, drones, spraying vehicles, human labor, and so on. Existing solutions for providing plants with substances also include fertigation and chemigation, in which appropriate substances are injected into an irrigation system, thereby causing the substances to be distributed to plants during watering.

The substances to be provided to plants to promote growth often require mixing, causing chemical reactions, or otherwise combining components to form a substance that is readily consumer by crops. As an example, Nitrogen, the most commonly used plant nutrient, cannot be directly consumer by plants in its naturally occurring form. Consequently, Nitrogen is commonly used as a component of a chemical substance which plants can consume. Existing solutions for creating combined substances for plant consumption often rely on an agronomist's judgment based on visual observation of the crops. This reliance further increases costs, time, and likelihood of human error.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

The disclosed embodiments include a method for optimizing chemigation of a crop. The method includes: identifying at least one image of at least one portion of the crop; analyzing, via machine imaging, the at least one image to identify at least one reference image respective of the crop; determining, based on the at least one reference image, at least one abnormality respective of the crop; and generating a chemical composition for treating the at least one abnormality.

The disclosed embodiments also include a system for optimizing chemigation of a crop. The system includes: a processing unit; and a memory, the memory containing instructions that, when executed by the processing unit, configure the system to: identify at least one image of at least one portion of the crop; analyze, via machine imaging, the at least one image to identify at least one reference image respective of the crop; determine, based on the at least one reference image, at least one abnormality respective of the crop; and generate a chemical composition for treating the at least one abnormality.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the disclosed embodiments.

FIG. 2 is a schematic diagram of an apparatus for optimizing chemigation of a crop according to an embodiment.

FIG. 3 is a flowchart illustrating a method for optimizing chemigation of plants according to an embodiment.

FIG. 4 is a flowchart illustrating a method for analyzing an image of a plant according to an embodiment.

FIG. 5 is a flowchart illustrating a method for generating a chemical composition for optimal chemigation according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

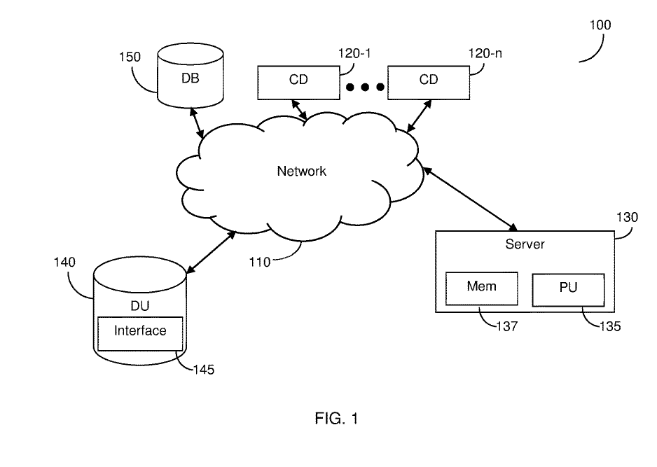

FIG. 1 shows an exemplary and non-limiting network diagram of a network system 100 utilized to describe the various embodiments. The network system 100 includes a network 110, a plurality of capturing devices (CDs) 120-1 through 120-n (hereinafter referred to individually as a capturing device 120 and collectively as capturing devices 120, merely for simplicity purposes), a server 130, a distribution unit (DU) 140, and a database (DB) 150.

The network 110 may be, but is not limited to, a wireless, cellular or wired network, a local area network (LAN), a wide area network (WAN), a metro area network (MAN), the Internet, the worldwide web (WWW), similar networks, and any combination thereof. The capturing devices 120 are communicatively connected to the network. Each capturing device 120 may be stationary or may be mobile, and is capable of capturing images of a crop or portions thereof. The capturing devices 120 may include, but are not limited to, a camera (e.g., a still camera, a video camera, and/or a combination thereof), an environmental sensor, and so on. Each environmental sensor may be, but is not limited to, a temperature sensor unit, a humidity sensor unit, a soil moisture sensor unit, a sunlight sensor unit, an irradiance sensor unit, and so on.

The server 130 is further communicatively connected to the network 110. The server 130 may be configured to analyze images captured by the capturing devices 120 and to generate an appropriate chemical composition for chemigation or other treatment of the crop based on the analysis. The chemical composition may define a mixture or a pure substance (e.g., a chemical compound, an alloy, a grouping of atoms of an element or ion, and so on). The chemical composition may further include a combination of fertilizer, fungicide, pesticide, and the like. The chemical composition may be for, but is not limited to, a nutrient, a chemical, a fertilizer, and so on. The analysis may include, but is not limited to, determining a crop abnormality featured in the images based on machine vision analysis of the images.

In an embodiment, the analysis may further be based on one or more environmental variables. The server 130 may be configured to receive or retrieve the environmental variables from environmental sensors of the capturing devices 120, from the database 150, and so on. The environmental variables may include, but are not limited to, a time of the image (e.g., a time of day, a time relative to a growing season, etc.), a location of the image, a temperature at the location, a radiation level at the location, carbon dioxide (CO₂) levels at the location, and so on. In another embodiment, the analysis may further be based on information related to previously generated chemical compositions respective of the crop. As an example, if the analysis indicates that that the crop was recently provided a single superphosphate fertilizer containing 15% Phosphorous Pentoxide (P₂O₅) and the abnormality has not improved, the analysis may yield generation of a single superphosphate fertilizer containing 16% Phosphorous Pentoxide.

Based on the analysis, the server 130 is configured to identify a type of crop featured in the images. In an embodiment, the identification may include matching the images to images stored in the database 150. The server 130 is further configured to determine whether there is an abnormality in the crop featured in the image based on the images. The abnormalities may include, but are not limited to, slow growth rate, diseases, yield deficiencies, presence of pests, and so on. The abnormality identifiers may include, but are not limited to, a color of the crop, a color ratio between portions of the crop, a texture, a color division, an unusual size or shape, pests, and so on.

A pest is typically an animal that will hinder crop growth by eating, infecting, or otherwise harming the plant. Whether an animal is a pest may depend on the type of the crop and/or based on growing preferences for the crop. In an embodiment, selections of pests may further be stored in the database 150. The selections may be made via a user interface, automatically based on past selections (e.g., if a certain insect has been previously selected as harmful for a type of crop above a predefined threshold, the insect may be automatically selected as harmful for future analyses of that type of crop), and so on.

The abnormality determination may include, but is not limited to, comparing the analyzed images to images of abnormality identifiers in the database 150. The comparison may further include matching the captured images to images existing in the database 150 respective of the crop in the captured images. In an embodiment, a plurality of images in the database 150 may be clustered to form a model representing an abnormality. In a further embodiment, the comparison may include matching the captured images to the model. The comparison may further be between images captured at or near the same time. The acceptable range of times may be predetermined. For example, an image captured at 1:00 PM may be compared to an imaged stored in the database that was captured between the hours of 12:00 PM and 2:00 PM.

Upon determining an abnormality, the server 130 is configured to determine a chemical composition and/or an irrigation pattern to correct the abnormality. The determination may be based on information stored in the database 150. In another embodiment, the server 130 may be configured to conduct a trial to determine which chemical composition among a plurality of potential chemical compositions results in the most effective treatment of the abnormality. Effectiveness of abnormality treatment may be measured based on, but not limited to, a disappearance rate of the abnormality, whether the treatment completely removes the abnormality, negative side effects associated with the chemical composition, combinations thereof, and so on. As an example, the server 130 may determine a first chemical composition and a second chemical composition for removing an abnormality. The first chemical composition may be provided to a first portion of the crop and the second chemical composition may be provided to the second portion of the crop. The server 130 may then monitor the first portion of the crop and the second portion of the crop to identify the respective rates of resolution of the abnormality. It is determined that the abnormality displayed by the first portion is completely resolved after a period of time, while the abnormality displayed by the second portion remains after the period of time.

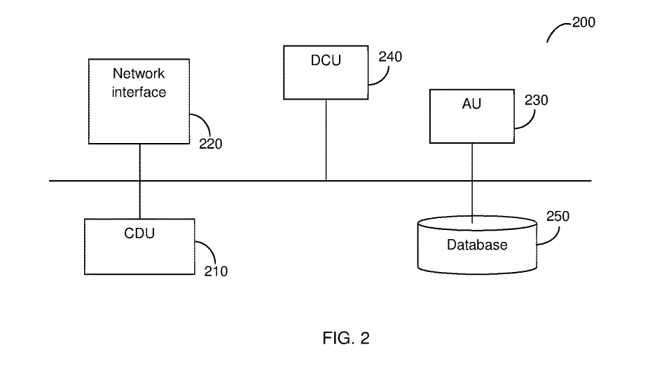

In an embodiment, the server 130 may be configured to continuously monitor images captured by the capturing devices 120 and to generate new chemical compositions based on changes to the crop featured in the monitored images. In a further embodiment, the server 130 may be configured to generate an alert in response to determining an abnormality during the monitoring. The alert may be sent to a user via, but not limited to, a website, an application program, and so on. Generating chemical compositions for optimal chemigation is described further herein below with respect to FIG. 2.

In an embodiment, the server 130 may further be configured to set environmental parameters at the location of the crop. The environmental parameters may be set based on, but not limited to, a list of encouraging environmental conditions for beneficial animals of the crop stored in the database 150. The beneficial animals may promote growth of the plant by, e.g., aiding in pollination, exposing the plant to nutrients, provide room for roots and plants to grow, and so on. The encouraging environmental conditions are environmental conditions that are likely to attract the beneficial animals to the location of the crop and may include, but are not limited to, a temperature, a humidity, a composition of air at the location, a type of soil, components in producing the chemical compositions, and so on. To this end, the server 130 may further be configured to generate chemical compositions so as to include any components that will attract beneficial insects.

The server 130 may be configured to send instructions for producing and/or for distributing the generated chemical composition to the distribution unit 140. In an embodiment, the server 130 may further be configured to store the generated chemical composition and the instructions in the database 150 respective of the crop for future analyses. The distribution unit 140 includes a network interface 145 for receiving the instructions from the server 130 over the network 110. The instructions may include, but are not limited to, a chemical composition, production parameters (e.g., temperature, moisture, times for reactions, chemical agents, etc.), patterns and amounts for distribution (e.g., an irrigation pattern and an amount of the chemical composition mixed with water to be used), and so on. The distribution unit 140 causes a reaction, mixes, or otherwise produces the chemical composition to be distributed to the crop based on the instructions. The distribution unit 140 may further cause distribution of the chemical composition that may be based on the instructions. The distribution may include, but is not limited to, injection of the chemical composition into an irrigation system that waters the crop (i.e., chemigation or fertigation), direct application of the chemical composition (via, e.g., a spraying vehicle, a drone, etc.), and so on.

In an embodiment, the determination of crop abnormalities, the generated chemical composition, and/or the instructions may be stored in the database 150. In a further embodiment, the server 130 may be configured to determine crop abnormalities by comparing the captured images to images associated with various crop abnormalities stored in the database 150. In another embodiment, the server 130 may be configured to retrieve the generated growth substance and/or the instructions from the database 150 respective of the images.

The server 130 typically includes a processing unit (PU) 135 coupled to a memory (Mem) 137. The processing unit 135 may comprise or be a component of a processor (not shown) or an array of processors coupled to the memory 137. The memory 137 contains instructions that can be executed by the processing unit 135. The instructions, when executed by the processing unit 135, cause the processing unit 135 to perform the various functions described herein. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

It should be noted that the server 130, the capturing devices 120, the distribution unit 140, and the database 150 are shown as separate components merely for simplicity purposes and without limitations on the disclosed embodiments. In some embodiments, the server 130 may comprise or be a component of a system including the capturing devices 120, the distribution unit 140, and/or the database 150.

FIG. 2 is an exemplary and non-limiting schematic diagram of an apparatus 200 for optimizing chemigation in a crop according to an embodiment. The apparatus 200 includes a capturing device unit (CDU) 210, a network interface 220, an analysis unit (AU) 230, a distribution control unit (DCU) 240, and a database 250.

The capturing device unit 210 may include one or more capturing devices. Each capturing device may be either stationary or mobile and is capable of capturing an image in which a crop or a portion thereof is featured. In an embodiment, any of the capturing devices may be an environmental sensor. The capturing devices may include, but are not limited to, a still camera, a video camera, a temperature sensor unit, a humidity sensor unit, a soil moisture sensor unit, a sunlight sensor unit, an irradiance sensor unit, combinations thereof, and so on. In another embodiment, the capturing device unit 210 may be communicatively connected to the network interface 220 such that the capturing device unit 210 may receive captured images or other signals over the network interface 220. The capturing device unit 210 sends images captured by the capturing devices respective of a crop to the analysis unit 230.

The analysis unit 230 receives the captured images and analyzes the images respective of the crop. The analysis may be based on information stored in the database 250. The information in the database may include, but is not limited to, images of abnormalities respective of different crops, chemical compositions that were previously effective in treating the abnormality, instructions for producing or distributing chemical compositions, and so on. The analysis unit 230 generates a chemical composition and sends instructions for producing and/or distributing the generated chemical composition to the distribution control unit 240.

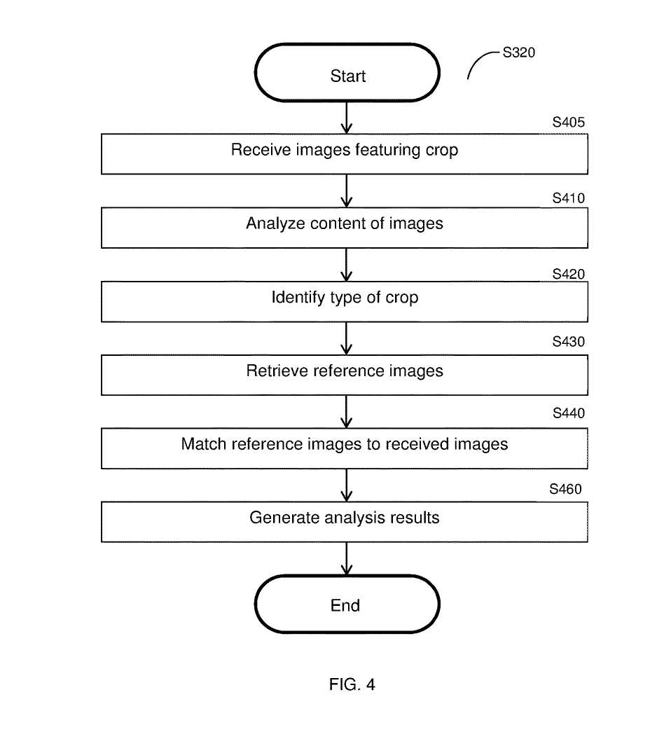

The analysis may include, but is not limited to, identifying a type of the crop featured in the captured images, determining whether there is an abnormality in the captured images, and determining a chemical composition for treating the abnormality. In an embodiment, the analysis unit 230 may continuously monitor images received from the capturing device unit 210 to identify new abnormalities and/or changes in abnormalities. Analysis of images respective of crops is described further herein above with respect to FIG. 4.

The distribution control unit 240 may be or may include a distribution unit for producing and/or distributing the generated chemical composition to the crop. In another embodiment, the chemigation unit 240 may be communicatively connected to the network interface 220 to cause an external distribution unit to perform production and/or distribution of the generated chemical composition.

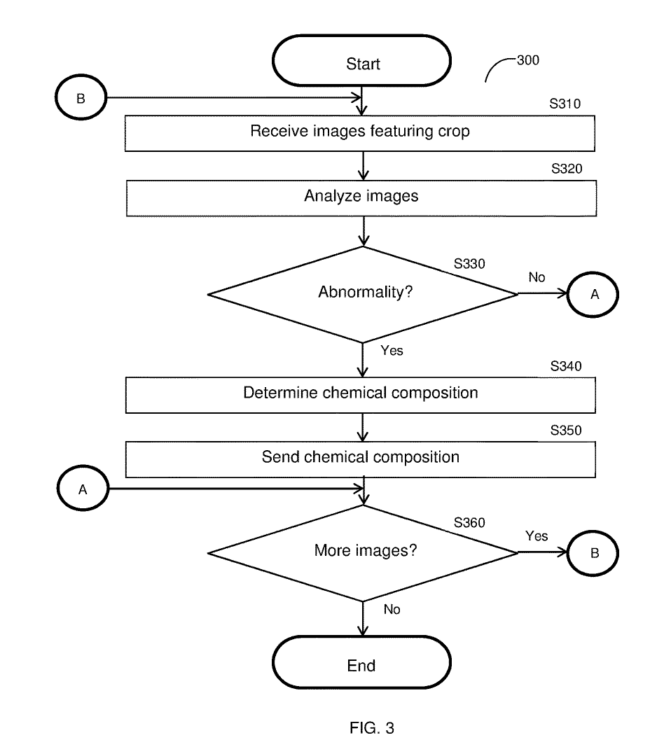

FIG. 3 is an exemplary and non-limiting flowchart 300 illustrating a method for optimizing chemigation of crops according to an embodiment.

In S310, one or more images featuring a crop are received. The images may be, but are not limited to, still images, videos, combinations thereof, and so on. In an embodiment, one or more signals from environmental sensors may also be received.

In S320, the images are analyzed respective of the crop. The analysis may include identifying a type of the crop and reference images respective of the identified type of crop. The reference images may include, but are not limited to, images featuring normal crops at various stages, images featuring abnormal crops, images featuring crops having preliminary abnormality indicators associated with subsequent abnormalities, and so on. The reference images may be of different types of crops, at different times of development, at different times of day, and so on. Analysis of images respective of a crop is described further herein below with respect to FIG. 4.

In S330, it is determined, based on the analysis, whether an abnormality is present on the crop and, if so, execution continues with S340; otherwise execution continues with S360. In an embodiment, S330 may further include predicting an expected future abnormality based on the analysis. The prediction may be based on preliminary abnormality indicators featured in the images.

In S340, a chemical composition for treating the abnormality is determined. The determined chemical composition may be a predetermined chemical composition that is associated with successful treatment of the abnormality. The determination may be further based on previous chemical compositions distributed to the crop. In an embodiment, S340 may further include determining instructions for producing and/or distributing the chemical composition. In optional S345, encouraging environmental conditions for attracting animals that would promote further plant growth may be determined as described further herein above with respect to FIG. 1.

In S350, the determined chemical composition is sent to, e.g., a distribution unit. In an embodiment, S350 may further include sending the instructions for producing and/or distributing the chemical composition. In optional S355, the determined encouraging environmental conditions may be sent to, e.g., an environmental control system for controlling environmental parameters of the area around the crop.

In S360, it is checked whether additional images have been received and, if so, execution continues with S310; otherwise, execution terminates. Receiving and analyzing additional images may allow for adapting the chemical composition being distributed to a crop to continuously improve the growth and health of the crop by responding to new abnormalities or identifying when treatment of existing abnormalities can be improved upon.

As a non-limiting example, a still image featuring a crop is received. The still image was captured at 7:00 AM at the 6^{th} week after planting of the crop. The image featuring the tomato crop is analyzed to identify that the crop is a tomato plant and to identify reference images featuring tomato plants taken during the morning around the 6^{th} week after planting. Based on the analysis, it is determined that the tomato is displaying the fungal disease leaf blight. A copper-based fungicide as well as instructions for distributing the fungicide via chemigation are determined for treating the abnormality. The determined fungicide and the instructions are sent to a distribution unit, thereby causing distribution of the fungicide to the crop based on the instructions. Additional images are later received and analyzed to determine that the crop is no longer displaying blight.

FIG. 4 is an exemplary and non-limiting flowchart S320 illustrating a method for analyzing images respective of a crop according to an embodiment. In S405, an image featuring a crop is received. In S410, the content of the images is analyzed by, for example, machine imaging (e.g., using machine vision techniques). The content analysis may include, but is not limited to, imaging, image processing, and so on. The content analysis may result in identification of features of the crop.

In S420, a type of the crop featured in the images is identified based on the analysis. The type of the crop may be identified by, for example, comparison to machine imaging results of images associated with various types of crops. The type of the crop may be identified when, for example, the images match an image associated with a particular type of crop above a predefined threshold.

In S430, reference images for the identified type of crop are retrieved. The retrieval may include, but is not limited to, extracting reference images associated with the type of crop from a database (e.g., the database 150). Each retrieved reference image may feature a normal crop, an abnormal crop, a preliminary abnormality indicator, and so on. The reference images may be retrieved based on information related to the captured images such as, but not limited to, a time of day of capturing, a relative time within a growing season of the capturing, and so on.

In S440, the retrieved reference images are matched to the analyzed images. The matching may include, but is not limited to, determining a degree of matching of each reference image respective of the analyzed images. In an embodiment, a reference image may be determined to match an analyzed image if the reference image matches the analyzed image above a predefined threshold. Alternatively or collectively, a reference image may be determined to match the analyzed image if the reference images has the highest degree of matching respective of the analyzed images.

In S450, analysis results are generated. The analysis results may include, but are not limited to, an indication of whether the crop featured in the analyzed images has an abnormality, an indication of the type of the abnormality, and so on. Each indication may be an association of the matching reference image with a normal crop, an abnormal crop, and/or a particular abnormality.

As a non-limiting example, a video featuring a crop is received and analyzed via machine imaging. Based on the analysis, the video is compared to images of different crops to identify that the crop in the video matches corn stalks featured in an image. Reference images for corn cops are retrieved. The reference images are matched to the video. One reference image featuring a corn stalk with stunted growth is matched to the video. Based on the matching, analysis results indicating that the corn stalk in the video has stunted growth are generated.

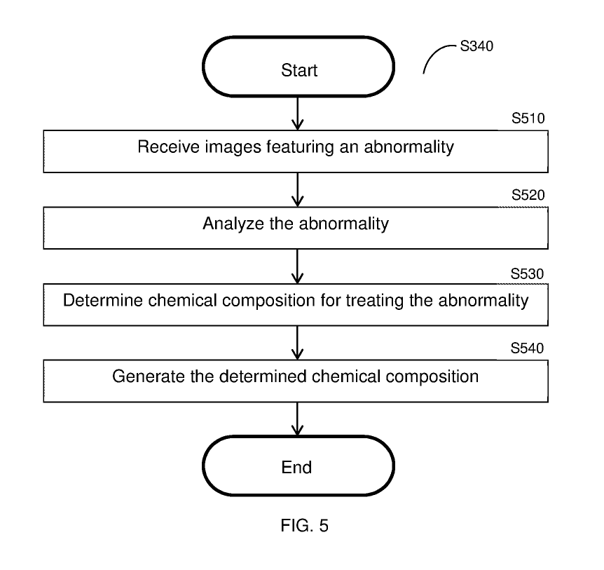

FIG. 5 is an exemplary and non-limiting flowchart S340 illustrating a method for determining a chemical composition for treating an abnormality appearing on a crop according to an embodiment. In S510, images featuring a crop displaying an abnormality are received. The images may be, but are not limited to, still images, videos, and so on.

In S520, the abnormality is analyzed. The analysis may include determining a type of the abnormality based on the images. Different types of abnormalities may be effectively treated using different chemical compositions.

In S530, a chemical composition for treating the analyzed abnormality is determined. In an embodiment, the determination may include retrieving a chemical composition used to treat the type of abnormality respective of the analysis. The chemical composition may be retrieved from a database (e.g., the database 150). In another embodiment, the determination may be based on a trial treatment. The trial treatment may be used, for example, if no chemical composition can be retrieved respective of the type of abnormality, if more than one chemical composition can be retrieved respective of the type of abnormality, and so on. For example, if two chemical compounds can be retrieved that effectively treat the abnormality, the chemical compounds may be applied to separate portions of the crop during a trial period and monitored to determine which chemical composition best treats the crop based on a disappearance rate of the abnormality respective of each chemical composition and/or whether each chemical composition completely treats the abnormality. In a further embodiment, S530 may further include storing the results of the trial treatment.

In S540, a chemical composition for treating the abnormality is generated based on the determination. In an embodiment, S540 may further include generating instructions for producing and/or distributing the chemical composition during treatment.

As a non-limiting example, images featuring a potato crop with several insects are received. The images are analyzed to determine that the insects featured in the images are tuber flea beetle larvae, a pest for potato plants. A mixture including potassium salts and pyrethrins is determined to be associated, in a database, with removing tuber flea beetles from potato crops. A chemical composition of the mixture is generated.

It should be noted that the embodiments disclosed herein are described with respect to chemigation merely for simplicity purposes and without limitation on the disclosed embodiments. The disclosed embodiments may be applicable to fertigation, direct distribution, and/or other methods for distributing chemicals and/or fertilizers without departing from the scope of the disclosure. It should further be noted that the embodiments disclosed herein are described with respect to one crop featured in the captured images merely for simplicity purposes and without limitations. Multiple crops may be featured in the images and analyzed to identify abnormalities in any or all of the crops without departing from the scope of the disclosure.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for optimizing chemigation of a crop, comprising:
identifying at least one image of at least one portion of the crop;
analyzing, via machine imaging, the at least one image to identify at least one reference image respective of the crop;
determining, based on the at least one reference image, at least one abnormality respective of the crop; and
generating a chemical composition for treating the at least one abnormality.

2. The method of claim 1, wherein analyzing the at least one image further comprises:
identifying a type of crop in the at least one image, wherein the at least one reference image is identified based on the identified type of crop.

3. The method of claim 1, wherein any of the determined at least one abnormality is a predicted future abnormality, wherein analyzing the at least one image further comprises:
identifying at least one preliminary abnormality indicator of the crop.

4. The method of claim 1, wherein the determination of the at least one abnormality is further based on at least one chemical composition that was previously distributed to the crop.

5. The method of claim 1, further comprising:
determining at least one instruction respective of the determined at least one abnormality, wherein each instruction is for any of: a production of the chemical composition, a distribution of the chemical composition, and setting environmental parameters for an area around the crop.

6. The method of claim 5, further comprising:
sending, to a distribution unit, any of: the chemical compound, and the at least one instruction.

7. The method of claim 1, wherein determining the at least one abnormality further comprises:
comparing the at least one received image to the at least one reference image to identify at least one abnormality identifier; and
determining, based on the at least one abnormality identifier, the at least one abnormality.

8. The method of claim 1, wherein the at least one reference image is identified based on any of: a time of day of the identified at least one image, and a time in a growing season of the identified at least one image.

9. The method of claim 1, wherein generating the chemical composition further comprises:
causing a first distribution of a first potential treatment composition and a second distribution of a second potential treatment composition to the crop;
monitoring the at least one abnormality for the first distribution and for the second distribution; and
determining which potential treatment composition is more effective based on any of: a disappearance rate of the at least one abnormality for each distribution, and whether the at least one abnormality has completely disappeared after each distribution.

10. The method of claim 1, wherein the chemical composition includes at least one of: fertilizer, fungicide, and pesticide.

11. A non-transitory computer readable medium having stored thereon instructions for causing one or more processing units to execute the method according to claim 1.

12. A system for optimizing chemigation of a crop, comprising:
a processing unit; and
a memory, the memory containing instructions that, when executed by the processing unit, configure the system to:
identify at least one image of at least one portion of the crop;
analyze, via machine imaging, the at least one image to identify at least one reference image respective of the crop;
determine, based on the at least one reference image, at least one abnormality respective of the crop; and
generate a chemical composition for treating the at least one abnormality.

13. The system of claim 12, wherein the system is further configured to:
identify a type of crop in the at least one image, wherein the at least one reference image is identified based on the identified type of crop.

14. The system of claim 12, wherein any of the determined at least one abnormality is a predicted future abnormality, wherein the system is further configured to:
identify at least one preliminary abnormality indicator of the crop.

15. The system of claim 12, wherein the determination of the at least one abnormality is further based on at least one chemical composition that was previously distributed to the crop.

16. The system of claim 12, wherein the system is further configured to:
determine at least one instruction respective of the determined at least one abnormality, wherein each instruction is for any of: a production of the chemical composition, a distribution of the chemical composition, and setting environmental parameters for an area around the crop.

17. The system of claim 16, wherein the system is further configured to:
send, to a distribution unit, any of: the chemical compound, and the at least one instruction.

18. The system of claim 12, wherein the system is further configured to:
compare the at least one received image to the at least one reference image to identify at least one abnormality identifier; and
determine, based on the at least one abnormality identifier, the at least one abnormality.

19. The system of claim 12, wherein the at least one reference image is identified based on any of: a time of day of the identified at least one image, and a time in a growing season of the identified at least one image.

20. The system of claim 12, wherein the system is further configured to:
cause a first distribution of a first potential treatment composition and a second distribution of a second potential treatment composition to the crop;
monitor the at least one abnormality for the first distribution and for the second distribution; and
determine which potential treatment composition is more effective based on any of: a disappearance rate of the at least one abnormality for each distribution, and whether the at least one abnormality has completely disappeared after each distribution.

21. The system of claim 12, wherein the chemical composition includes at least one of: fertilizer, fungicide, and pesticide.
